(19) United States
(12) Patent Application Publication
(10) Pub. No.: US 2025/0248526 A1
(43) Pub. Date: Aug. 7, 2025

(54) Electric motion chair

(71) Applicant: Cooler Master Technology Inc., Taipei City (TW)

(72) Inventors: Chun-Ta Chen, Taipei City (TW); Yao Shiao, Taipei City (TW); Shang Che Lee, Taipei City (TW); Mingwan Lien, Taipei City (TW)

(21) Appl. No.: 19/036,056

(22) Filed: Jan. 24, 2025

(30) Foreign Application Priority Data
Feb. 2, 2024 (TW) 113104100

(51) Int. Cl. A47C 15/00; A47C 3/18; A47C 3/20; A47C 7/72

(52) U.S. Cl. CPC A47C 15/004; A47C 3/18; A47C 3/20; A47C 7/723; A47C 7/727

(57) ABSTRACT

An electric motion chair may include a chair, a motor, one or more sensors, and a control system. The motor is coupled to the chair and configured to move the chair in one or more degrees of freedom. The motor is further configured to include an activated state and a deactivated state. The activated state includes the motor moving the chair and the deactivated state includes the motor stopping to move the chair. Each one or more sensors is configured to detect an object at a respective relative distance to each one or more sensors. The control system electrically coupled to the one or more sensors and electrically coupled to the motor. The control system configured to automatically transition the motor from the activated state to the deactivated state when the object is detected.

### RELATED APPLICATIONS

This US application claims the benefit of priority to Taiwan application no. 113104100, filed on Feb. 2, 2024, of which is incorporated herein by reference in its entirety.

### TECHNICAL FIELD

The present disclosure is related to safety features of moving chairs in general and more particularly but not limited to electric motion chairs.

### BACKGROUND OF THE INVENTION

Immersive gaming chairs (or haptic gaming chairs) and virtual reality chairs (VR chairs) integrate haptic feedback technology to turn a virtual environment into vibrations and motions that a user can feel in real-time while gaming, watching movies, listening to music, and virtually going on amusement park rides. Often placed in a home environment, the gaming and VR chairs may vibrate and move in all of the six degrees of freedom (surge, heave, sway, roll, pitch, and yaw) to enhance levels of enjoyment and intensity of emotions.

As gaming and VR chairs become more and more immersive, accessories or mounts such as footrests, foot pedals, joysticks, steering wheels have become more of a requirement. Thus, the amount of space the gaming and VR chairs take in the home has expanded. With children, adults, and pets often found near the gaming and VR chairs, real-time movement of the gaming and VR chairs may be problematic and dangerous for the children, adults, and pets.

### SUMMARY OF THE INVENTION

The present disclosure provides an automatic safety feature for electric motion chairs to prevent children, adults, and pets from being hurt or hit from the electric motion chair.

In some aspects, the techniques described herein relate to an electric motion chair configured to electrically couple to haptic-enhanced immersive content, including a chair, a motor, one or more sensors, and a control system. The motor is coupled to the chair and configured to move the chair in one or more degrees of freedom. The motor is further configured to include an activated state and a deactivated state. The activated state includes the motor moving the chair and the deactivated state includes the motor stopping to move the chair. Each one or more sensors is configured to detect an object at a respective relative distance to each one or more sensors. The control system is electrically coupled to the one or more sensors and electrically coupled to the motor. The control system is configured to automatically transition the motor from the activated state to the deactivated state when the object is detected.

In some aspects, the techniques described herein relate to an electric motion chair, wherein the one or more degrees of freedom includes an x-axis linear motion, a y-axis linear motion, a z-axis linear motion, an x-axis rotational motion, a y-axis rotational motion, and a z-axis rotational motion. The x-axis linear motion includes a forward and backward motion, the y-axis linear motion includes a leftward and rightward motion, and the z-axis linear motion includes an upward and downward motion. The x-axis rotational motion includes a tilting side-to-side motion, the y-axis rotational motion includes a tilting forward and backward motion, and the z-axis rotational motion includes a turning left and right motion.

In some aspects, the techniques described herein relate to an electric motion chair, wherein the one or more degrees of freedom further includes a first motion group, a second motion group, and a third motion group. The first motion group includes one or more of the x-axis linear motion, the y-axis linear motion, the z-axis linear motion, the x-axis rotational motion, the y-axis rotational motion, and the z-axis rotational motion. The second motion group includes one or more of the x-axis linear motion, the y-axis linear motion, the z-axis linear motion, the x-axis rotational motion, the y-axis rotational motion, and the z-axis rotational motion not included in the first motion group. The third motion group includes one or more of the x-axis linear motion, the y-axis linear motion, the z-axis linear motion, the x-axis rotational motion, the y-axis rotational motion, and the z-axis rotational motion not included in the first motion group and the second motion group.

In some aspects, the techniques described herein relate to an electric motion chair, further including a base. The base is coupled to the chair and configured to support the chair thereon. The motor is disposed in the chair or in the base and configured to move the chair in the one or more degrees of freedom relative to the base. Each one or more sensors is disposed in the chair or in the base.

In some aspects, the techniques described herein relate to an electric motion chair, wherein the motor includes a first motor and a second motor. The first motor is disposed in the base, and the second motor is disposed in the chair. The first motor is configured to move the chair in the first motion group or the first motion group and the third motion group, and the second motor configured to move the chair in the second motion group or the second motion group and the third motion group. When the first motor is configured to move the chair in the first motion group and the third motion group, the second motor is configured to move the chair in the second motion group, and vice versa. When the second motor is configured to move the chair in the second motion group and the third motion group, the first motor is configured to move the chair in the first motion group, and vice versa.

In some aspects, the techniques described herein relate to an electric motion chair, further including a platform. The platform is coupled to the chair and coupled to the base. The platform is disposed between the chair and the base. The platform is configured to support the chair thereon. The motor is disposed in the chair, or in the base, or in the platform. Each one or more sensors is disposed in the chair, or in the base, or in the platform.

In some aspects, the techniques described herein relate to an electric motion chair, wherein the motor includes a first motor, a second motor, and a third motor. The first motor is disposed in the base, the second motor is disposed in the chair, and the third motor is disposed in the platform. The first motor is configured to move the chair in the first motion group, the second motor configured to move the chair in the second motion group, and the third motor configured to move the chair in the third motion group.

In some aspects, the techniques described herein relate to an electric motion chair, wherein the motor is further configured to include a decelerated state and the respective relative distance of each one or more sensors configured to detect the object includes a deactivated distance and a decelerated distance. The decelerated state includes the motor moving the chair at a reduced speed relative to the activated state. The decelerated distance is greater than the deactivated distance. The control system is further configured to automatically transition the motor from the activated state to the decelerated state when the object is at the decelerated distance. The control system is further configured to automatically transition the motor from the decelerated state to the deactivated state when the object is at the deactivated distance.

In some aspects, the techniques described herein relate to an electric motion chair, wherein the control system is further configured to automatically transition the motor from the activated state to the decelerated state for a predetermined decelerated period of time when the object is at the decelerated distance.

In some aspects, the techniques described herein relate to an electric motion chair, further including an alarm, and the respective relative distance of each one or more sensors configured to detect the object further includes a warning distance. The control system is further electrically coupled to the alarm. The control system is further configured to automatically trigger the alarm when the object is at the warning distance. The warning distance is greater than the decelerated distance. The alarm is configured to provide an audible warning or a visual warning or the audible warning and the visual warning.

In some aspects, the techniques described herein relate to an electric motion chair, wherein the alarm includes a display device. The display device is configured to provide the audible warning and the visual warning. In some aspects, the techniques described herein relate to an electric motion chair, wherein the control system is further configured to automatically trigger the alarm for a predetermined alarm period of time when the object is at the warning distance.

In some aspects, the techniques described herein relate to an electric motion chair, further including a user interface device. The user interface device is configured to generate an activation signal by a user. The control system is further electrically coupled to the user interface device. The control system is further configured to receive the activation signal and transition the motor from the deactivated state to the activated state when the activation signal is received. In some aspects, the techniques described herein relate to an electric motion chair, wherein the user interface device includes a touchscreen monitor, a mouse device, or a keyboard device or the touchscreen monitor and the mouse device or the touchscreen monitor and the keyboard device.

In some aspects, the techniques described herein relate to an electric motion chair, wherein each one or more sensors is further configured to include a frequency. The frequency includes frequencies between 30 kHz and 80 kHz, inclusive.

In some aspects, the techniques described herein relate to an electric motion chair, wherein the one or more sensors includes six one or more sensors, and wherein each one or more sensors is further configured to include a beam angle. The one or more sensors is circularly disposed and each neighboring one or more sensors is disposed at an equal distance apart. The beam angle includes a sixty-degree beam angle.

In some aspects, the techniques described herein relate to an electric motion chair, wherein the one or more sensors includes twelve one or more sensors, and wherein each one or more sensors is further configured to include a beam angle. The one or more sensors is equiangular quadrilateral disposed and each neighboring one or more sensors disposed at an equal distance apart. The beam angle of each neighboring one or more sensors overlaps.

In some aspects, the techniques described herein relate to an electric motion chair, wherein the object includes a living being or a non-living being. In some aspects, the techniques described herein relate to an electric motion chair, wherein the one or more sensors includes an ultrasonic sensor. In some aspects, the techniques described herein relate to an electric motion chair, wherein the control system includes one or more of a central processing unit, a processor, a controller circuit, and a programmable logic controller, or any combination of the central processing unit, the processor, the controller circuit, and the programmable logic controller.

### BRIEF DESCRIPTION OF DRAWINGS

Unless specified otherwise, the accompanying drawings illustrate aspects of the innovative subject matter described herein. Referring to the drawings, wherein like reference numerals indicate similar parts throughout the several views, several examples of electric motion chairs incorporating aspects of the presently disclosed principles are illustrated by way of example, and not by way of limitation.

FIG. 1 illustrates an electric motion chair, according to one embodiment of the present disclosure.

FIG. 2 is a schematic diagram of the electric motion chair of FIG. 1, according to one embodiment of the present disclosure.

FIG. 3 is an alternative schematic diagram of the electric motion chair of FIG. 1, according to one embodiment of the present disclosure.

FIG. 4 illustrates detection ranges of the electric motion chair of FIG. 1, according to one embodiment of the present disclosure.

FIG. 5 illustrates alternative detection ranges of the electric motion chair of FIG. 4, according to one embodiment of the present disclosure.

FIG. 6 is a flow chart of the electric motion chair of FIG. 1, according to one embodiment of the present disclosure.

FIG. 7 is a decision box diagram of the electric motion chair of FIG. 6, according to one embodiment of the present disclosure.

### DETAILED DESCRIPTION

The following describes various principles related to electric motion chairs by way of reference to specific examples of chairs, bases, and platforms, including specific arrangements and examples of electrical coupling of control systems to motors and to sensors embodying innovative concepts. More particularly, but not exclusively, such innovative principles are described in relation to selected examples of electrical coupling of control systems to motors and to sensors, and well-known functions or constructions are not described in detail for purposes of succinctness and clarity. Nonetheless, of the disclosed principles can be incorporated in various other embodiments of different electrical coupling of control systems to motors and to sensors to achieve any of a variety of desired outcomes, characteristics, and/or performance criteria.

Thus, electrical coupling of control systems to motors and to sensors having attributes that are different from those specific examples discussed herein can embody of the innovative principles, and can be used in applications not described herein in detail. Accordingly, embodiments of electrical coupling of control systems to motors and to sensors not described herein in detail also fall within the scope of this disclosure, as will be appreciated by those of ordinary skill in the relevant art following a review of this disclosure.

Example embodiments as disclosed herein are directed to electric motion chairs configured to electrically couple to haptic-enhanced immersive content. The electric motion chairs can be immersive gaming chairs (or haptic gaming chairs) and virtual reality chairs (VR chairs). The haptic-enhanced immersive content can be games, movies, virtual reality concerts, and virtual reality amusement park rides electrically coupled to the electric motion chairs, where users play games, watch movies, listen to music, and virtually go on amusement park rides. Electric motion chairs can vibrate, move, and provide sounds so that the user can feel or engage in real-time with what is being seen; thus, feeling present in the experience. Virtual reality is one type of immersive technology where the user uses a Virtual Reality headset to interact within a digital simulation of a virtual world.

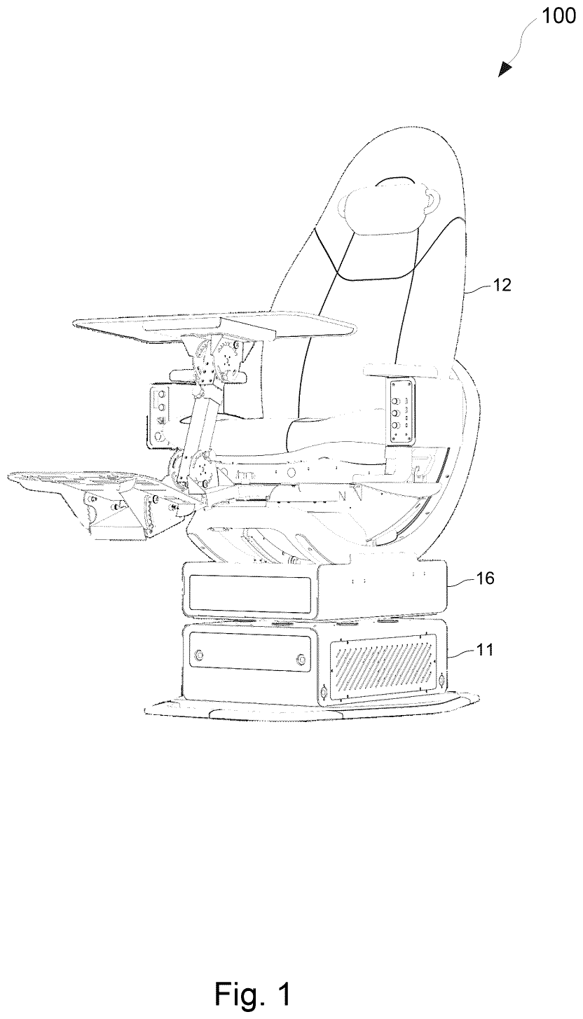

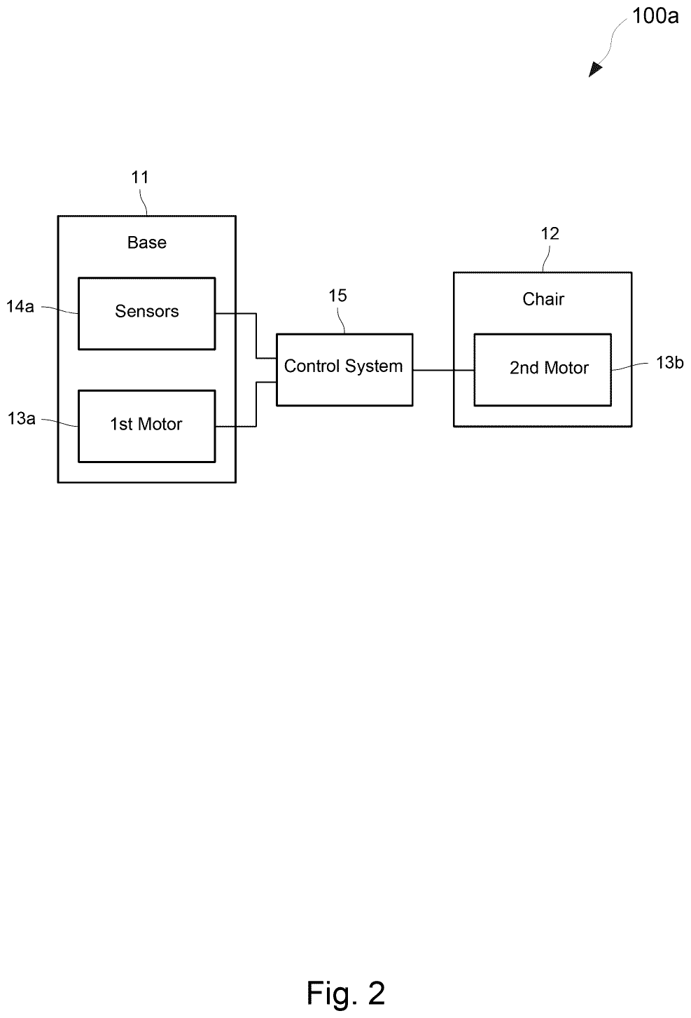

FIGS. 1 and 2 include at least one embodiment of an electric motion chair 100/100a/100b. The electric motion chair 100/100a/100b is configured to electrically couple to haptic-enhanced immersive content, and includes a chair 12, a motor 13a/13b/13c, one or more sensors 14a/14c, and a control system 15. The motor 13a/13b/13c is coupled to the chair 12 and configured to move the chair 12 in one or more degrees of freedom. The motor 13a/13b/13c is further configured to include an activated state and a deactivated state. The activated state includes the motor 13a/13b/13c moving the chair 12 and the deactivated state includes the motor 13a/13b/13c stopping to move the chair 12. Each one or more sensors 14a/14c is configured to detect an object (not shown) at a respective relative distance A1, A2, A3 to each one or more sensors 14a/14c. The control system 15 is electrically coupled to the one or more sensors 14a/14c and electrically coupled to the motor 13a/13b/13c. The control system 15 is configured to automatically transition the motor 13a/13b/13c from the activated state to the deactivated state when the object is detected.

In some embodiments, the one or more degrees of freedom includes an x-axis linear motion, a y-axis linear motion, a z-axis linear motion, an x-axis rotational motion, a y-axis rotational motion, and a z-axis rotational motion. The x-axis linear motion includes a forward and backward motion (or surge), the y-axis linear motion includes a leftward and rightward motion (or sway), and the z-axis linear motion includes an upward and downward motion (or heave). The x-axis rotational motion includes a tilting side-to-side motion (or roll), the y-axis rotational motion includes a tilting forward and backward motion (or pitch), and the z-axis rotational motion includes a turning left and right motion (or yaw).

In some embodiments, the one or more degrees of freedom further includes a first motion group, a second motion group, and a third motion group. The first motion group includes one or more of the x-axis linear motion, the y-axis linear motion, the z-axis linear motion, the x-axis rotational motion, the y-axis rotational motion, and the z-axis rotational motion. The second motion group includes one or more of the x-axis linear motion, the y-axis linear motion, the z-axis linear motion, the x-axis rotational motion, the y-axis rotational motion, and the z-axis rotational motion not included in the first motion group. The third motion group includes one or more of the x-axis linear motion, the y-axis linear motion, the z-axis linear motion, the x-axis rotational motion, the y-axis rotational motion, and the z-axis rotational motion not included in the first motion group and the second motion group.

In some embodiments, the electric motion chair 100/100a/100b further includes a base 11. The base 11 is coupled to the chair 12 and configured to support the chair 12 thereon. The motor 13a/13b/13c is disposed in the chair 12 or in the base 11 and configured to move the chair 12 in the one or more degrees of freedom relative to the base 11. Each one or more sensors 14a/14c is disposed in the chair 12 or in the base 11. The base 11 can be placed on a ground.

In some embodiments, the motor 13a/13b/13c includes a first motor 13a and a second motor 13b. The first motor 13a is disposed in the base 11, and the second motor 13b is disposed in the chair 12. The first motor 13a is configured to move the chair 12 in the first motion group or the first motion group and the third motion group, and the second motor 13b configured to move the chair 12 in the second motion group or the second motion group and the third motion group. When the first motor 13a is configured to move the chair 12 in the first motion group and the third motion group, the second motor 13b is configured to move the chair 12 in the second motion group, and vice versa. When the second motor 13b is configured to move the chair 12 in the second motion group and the third motion group, the first motor 13a is configured to move the chair 12 in the first motion group, and vice versa.

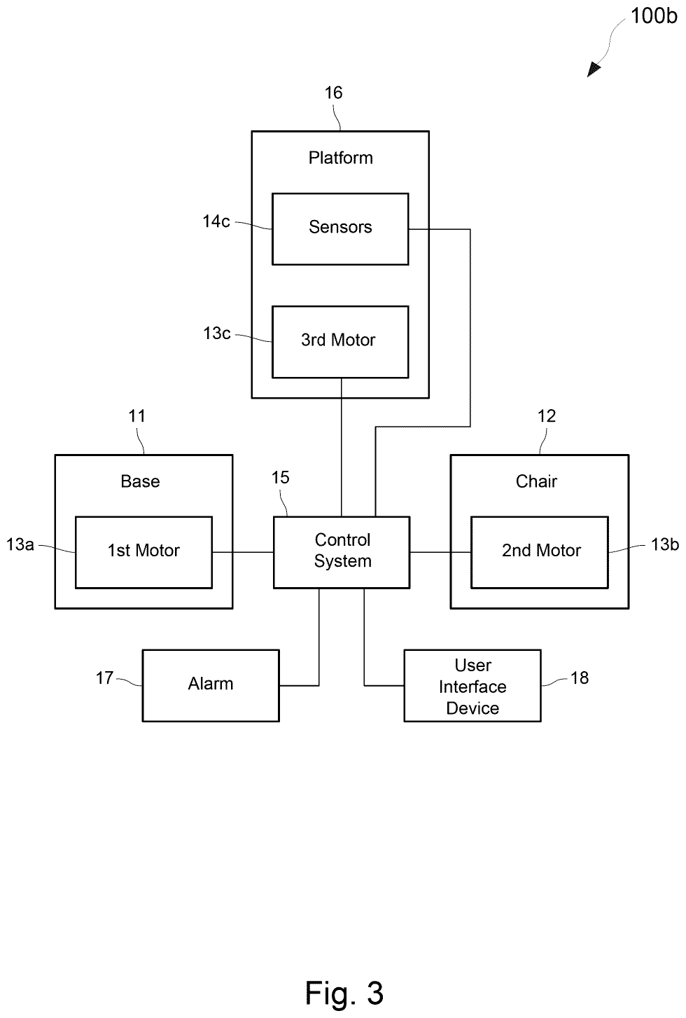

FIG. 3 includes at least one embodiment of an alternative electric motion chair 100/100b. In some embodiments, the electric motion chair 100/100b further includes a platform 16. The platform 16 is coupled to the chair 12 and coupled to the base 11. The platform 16 is disposed between the chair 12 and the base 11. The platform 16 is configured to support the chair 12 thereon. The motor 13a/13b/13c is disposed in the chair 12, or in the base 11, or in the platform 16. Each one or more sensors 14a/14c is disposed in the chair 12, or in the base 11, or in the platform 16. In some embodiments, the one or more sensors 14a/14c is disposed at perimeter sides or edges of the chair 12, the base 11, or the platform 16.

In some embodiments, the motor 13a/13b/13c includes a first motor 13a, a second motor 13b, and a third motor 13c. The first motor 13a is disposed in the base 11, the second motor 13b is disposed in the chair 12, and the third motor 13c is disposed in the platform 16. The first motor 13a is configured to move the chair 12 in the first motion group, the second motor 13b configured to move the chair 12 in the second motion group, and the third motor 13c configured to move the chair 12 in the third motion group.

In some embodiments, the motor 13a/13b/13c is further configured to include a decelerated state and the respective relative distance A1, A2, A3 of each one or more sensors 14a/14c configured to detect the object includes a deactivated distance A3 and a decelerated distance A2. The decelerated state includes the motor 13a/13b/13c moving the chair 12 at a reduced speed relative to the activated state. The decelerated distance A2 is greater than the deactivated distance A3. The control system 15 is further configured to automatically transition the motor 13a/13b/13c from the activated state to the decelerated state when the object is at the decelerated distance A2. The control system 15 is further configured to automatically transition the motor 13a/13b/13c from the decelerated state to the deactivated state when the object is at the deactivated distance A3.

In some embodiments, the control system 15 is further configured to automatically transition the motor 13a/13b/13c from the activated state to the decelerated state for a predetermined decelerated period of time when the object is at the decelerated distance A2. As an example, the predetermined decelerated period of time can be 3 seconds.

In some embodiments, the electric motion chair 100/100b further includes an alarm 17, and the respective relative distance A1, A2, A3 of each one or more sensors 14a/14c configured to detect the object further includes a warning distance A1. The control system 15 is further electrically coupled to the alarm 17. The control system 15 is further configured to automatically trigger the alarm 17 when the object is at the warning distance A1. The warning distance A1 is greater than the decelerated distance A2. The alarm 17 is configured to provide an audible warning or a visual warning or the audible warning and the visual warning.

In some embodiments, the alarm 17 includes a display device. The display device is configured to provide the audible warning and the visual warning. In some embodiments, the control system 15 is further configured to automatically trigger the alarm 17 for a predetermined alarm 17 period of time when the object is at the warning distance A1. As an example, the predetermined alarm 17 period of time can be 5 seconds.

In some embodiments, the electric motion chair 100/100b further includes a user interface device 18 (or UID). The user interface device 18 is configured to generate an activation signal by a user. The control system 15 is further electrically coupled to the user interface device 18. The control system 15 is further configured to receive the activation signal and transition the motor 13a/13b/13c from the deactivated state to the activated state when the activation signal is received. In some embodiments, the user interface device 18 includes a touchscreen monitor, a mouse device, or a keyboard device or the touchscreen monitor and the mouse device or the touchscreen monitor and the keyboard device.

In some embodiments, each one or more sensors 14a/14c is further configured to include a frequency. The frequency includes frequencies between 30 kHz and 80 kHz, inclusive. In some embodiments, each one or more sensors 14a/14c is further configured to include a resolution. The resolution includes a resolution of 1 centimeters. In some embodiments, the relative distance includes a maximum relative distance. The maximum relative distance includes a distance of up to 4 meters.

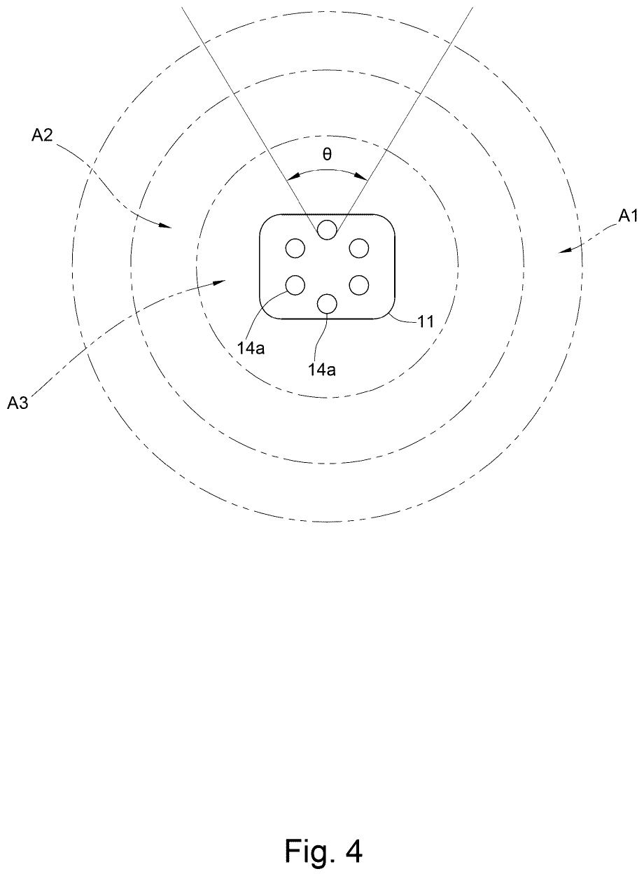

FIG. 4 includes at least one embodiment of detection ranges of another alternative electric motion chair 100/100a/100b. In some embodiments, the one or more sensors 14a/14c includes six one or more sensors 14a/14c. Each one or more sensors 14a/14c is further configured to include a beam angle θ (or detection range). The one or more sensors 14a/14c is circularly disposed and each neighboring one or more sensors 14a/14c is disposed at an equal distance apart. The beam angle θ includes a 60-degree beam angle θ.

In some embodiments, the one or more sensors 14a/14c includes eight one or more sensors 14a/14c (not shown). The one or more sensors 14a/14c is circularly disposed and each neighboring one or more sensors 14a/14c is disposed at an equal distance apart. The beam angle θ includes a 45-degree beam angle θ.

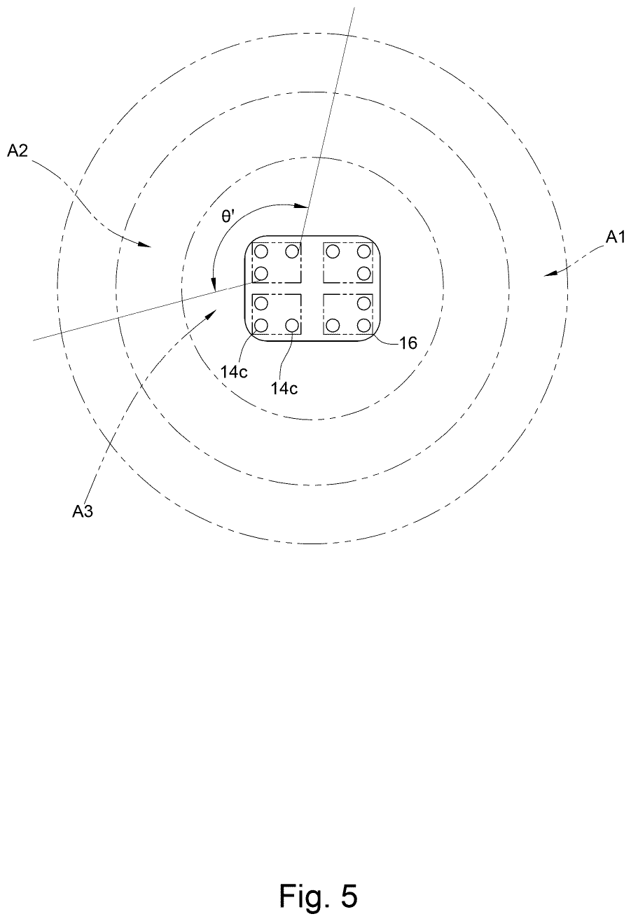

FIG. 5 includes at least one embodiment of detection ranges of yet another alternative electric motion chair 100/100a/100b. In some embodiments, the one or more sensors 14a/14c includes twelve one or more sensors 14a/14c. Each one or more sensors 14a/14c is further configured to include a beam angle θ. The one or more sensors 14a/14c is equiangular quadrilateral disposed and each neighboring one or more sensors 14a/14c is disposed at an equal distance apart. The beam angle θ of each neighboring one or more sensors 14a/14c overlaps. The beam angle θ includes a 45-degree beam angle θ and each neighboring three one or more sensors 14a/14c disposed at corners include a combined beam angle θ (or detection range) of 135-degrees.

In some embodiments, the one or more sensors 14a/14c includes an ultrasonic sensor. The ultrasonic sensor can be a piezoelectric transducer. The ultrasonic sensor converts electrical signals into mechanical vibrations, and mechanical vibrations into electrical signals. The ultrasonic sensor can be a transceiver which operates as both a speaker and microphone at a single frequency. The ultrasonic sensor captures the difference in time between an emitted and received echo. The following equation shows a distance calculation for the ultrasonic sensor: dOneWay=(tRoundTrip×VSound)/2. dOneWay is the distance between each one or more sensors 14a/14c and the object, tRoundTrip is the captured round-trip time, and VSound is the velocity of sound through air. As an example, when the speed of sound is 340 m/s, and the captured round-trip time is 0.06 seconds, the distance between each one or more sensors 14a/14c and the object is about 1 meter.

In some embodiments, the object includes a living being or a non-living being. In some embodiments, the control system 15 includes one or more of a central processing unit, a processor, a controller circuit, and a programmable logic controller, or any combination of the central processing unit, the processor, the controller circuit, and the programmable logic controller. In some embodiments, the motor 13a/13b/13c includes the motor 13a/13b/13c and one or more of a central processing unit, a processor, a controller circuit, and a programmable logic controller, or any combination of the central processing unit, the processor, the controller circuit, and the programmable logic controller. In some embodiments, the one or more sensors 14a/14c include the one or more sensors 14a/14c and one or more of a central processing unit, a processor, a controller circuit, and a programmable logic controller, or any combination of the central processing unit, the processor, the controller circuit, and the programmable logic controller.

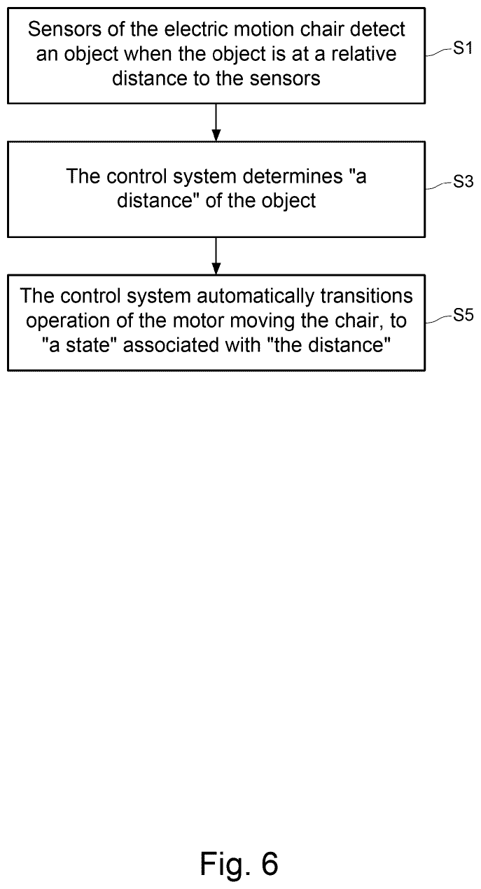

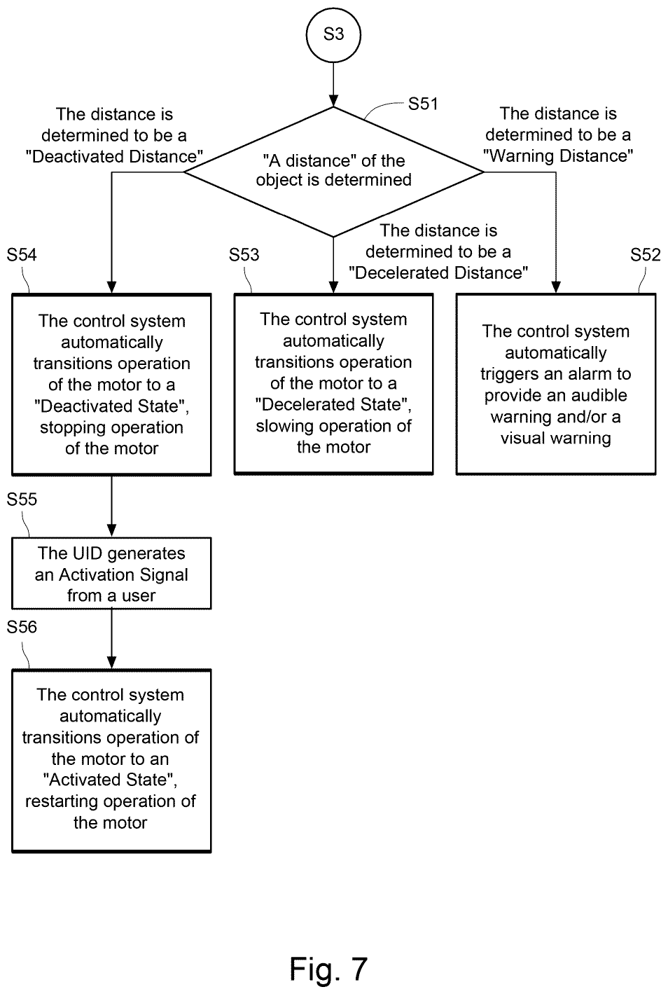

FIGS. 6 and 7 include at least one embodiment of a flow chart and decision box diagram of an electric motion chair 100/100a/100b. In step S1, each one or more sensors 14a/14c of the electric motion chair 100/100a/100b can detect an object when the object is at a relative distance A1, A2, A3 to each one or more sensors 14a/14c. The one or more sensors 14a/14c can be an amount disposed to encompass a 360-degree area surrounding the electric motion chair 100/100a/100b. The relative distance A1, A2, A3 can be a deactivated distance A3, a decelerated distance A2, and a warning distance A1. The warning distance A1 is greater than the decelerated distance A2 and the decelerated distance A2 is greater than the deactivated distance A3. As an example, the deactivated distance A3 can be from 0 to 1 meters, the decelerated distance A2 can be from 1 meter to 1.5 meters, and the warning distance A1 can be from 1.5 meters to 2 meters. Alternatively, as an example, the deactivated distance A3 can be from 0 to 1 meters, the decelerated distance A2 can be from 1 meter to 2 meters, and the warning distance A1 can be from 2 meters to 3 meters. In step S3/S51, the control system 15 determines whether the relative distance A1, A2, A3 is a deactivated distance A3, a decelerated distance A2, or a warning distance A1. The control system 15 can receive input signals from the one or more sensors 14a/14c to determine whether the relative distance A1, A2, A3 is a deactivated distance A3, a decelerated distance A2, or a warning distance A1. In step S52, when the control system 15 determines the object to be at a warning distance A1, the control system 15 can automatically trigger an alarm 17 to provide an audible warning and/or a visual warning. In step S5, the control system 15 can automatically transition operation of the motor 13a/13b/13c moving the chair 12, to “a state” associated with “the distance”. In step S53, when the control system 15 determines the object to be at a decelerated distance A2, the control system 15 can automatically transition operation of the motor 13a/13b/13c to a decelerated state, slowing operation of the motor 13a/13b/13c. Thus, real-time movement of the electric motion chair 100/100a/100b is slowed. In step S54, when the control system 15 determines the object to be at a deactivated distance A3, the control system 15 can automatically transition operation of the motor 13a/13b/13c to a deactivated state, stopping operation of the motor 13a/13b/13c. Thus, real-time movement of the electric motion chair 100/100a/100b is stopped, preventing problematic or dangerous situations from occurring to objects such as children, adults, and pets. In step S55, the user interface device 18 can generate an activation signal by a user. The control system 15 can output an activation display signal to the user interface device 18 when operation of the motor 13a/13b/13c is transitioned to the deactivated state. When the activation display signal is received by the user interface device 18, the user interface device 18 can generate an activation trigger which can be viewed on a touchscreen monitor. When the user triggers the activation trigger, the user interface device 18 can generate the activation signal. In step S56, the control system 15 can receive the activation signal from the user interface device 18 and automatically transition operation of the motor 13a/13b/13c to an activated state, restarting operation of the motor 13a/13b/13c, and thus, operation of the electric motion chair 100/100a/100b.

The electric motion chair 100/100a/100b of the embodiments described herein provide an automatic safety feature preventing injury to objects such as children, adults, and pets. The electric motion chair 100/100a/100bs can be gaming and VR chairs, which can be placed in homes and electrically coupled to haptic-enhanced immersive content. The one or more sensors 14a/14c is disposed in the base 11, chair 12 or platform 16, whereby the beam angle θ (or detection ranges) covers a 360-degree area surrounding the electric motion chair 100/100a/100b. Each one or more sensors 14a/14c detect an object when the object is at a relative distance A1, A2, A3. The control system 15 receives input signals from the one or more sensors 14a/14c and determines whether the relative distance A1, A2, A3 is a deactivated distance A3, a decelerated distance A2, or a warning distance A1. An alarm 17 is triggered to provide an audible warning and/or a visual warning to those determined to be within the warning distance A1. Further, a predetermined alarm 17 period of time can be set so that the alarm 17 is only triggered when there is a greater probability of danger and not when someone, some animal, or something may simply pass through the warning distance A1. Thus, the user and someone or some animal can be warned that they or it is too close to the electric motion chair 100/100a/100b. Also, in addition to real-time movement of the electric motion chair 100/100a/100b being stopped when the control system 15 determines the relative distance A1, A2, A3 to be a deactivated distance A3, real-time movement of the electric motion chair 100/100a/100b can also be slowed. When the control system 15 determines the relative distance A1, A2, A3 to be a decelerated distance A2, the user will not need to completely stop immersive experience of the electronic motion chair 12. In this scenario, real-time movement of the electric motion chair 100/100a/100b is slowed, continuing a user's immersive experience at a slower pace, while decreasing the probability for problematic or dangerous situations from occurring and allowing time for those in the vicinity to move away from potential danger. Further, a predetermined decelerated period of time can be set so that the motor 13a/13b/13c only slows when there is a greater probability of danger and not when someone may simply be passing through the decelerated distance A2. Thus, a safer electric motion chair 100/100a/100b is provided for gaming and VR chairs having expanded required space in home environments.

Therefore, embodiments disclosed herein are well adapted to attain the ends and advantages mentioned as well as those that are inherent therein. The particular embodiments disclosed above are illustrative only, as the embodiments disclosed may be modified and practiced in different but equivalent manners apparent to those of ordinary skill in the relevant art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some number. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean than one of the element that it introduces.

1. An electric motion chair configured to electrically couple to haptic-enhanced immersive content, comprising:
a chair;
a motor coupled to the chair, the motor configured to move the chair in one or more degrees of freedom, the motor further configured to include an activated state and a deactivated state, the activated state includes the motor moving the chair, the deactivated state includes the motor stopping to move the chair;
one or more sensors, each one or more sensors configured to detect an object at a respective relative distance to each one or more sensors; and
a control system electrically coupled to the one or more sensors and electrically coupled to the motor, the control system configured to automatically transition the motor from the activated state to the deactivated state when the object is detected.

2. The electric motion chair of claim 1, wherein the one or more degrees of freedom includes an x-axis linear motion, a y-axis linear motion, a z-axis linear motion, an x-axis rotational motion, a y-axis rotational motion, and a z-axis rotational motion, the x-axis linear motion includes a forward and backward motion, the y-axis linear motion includes a leftward and rightward motion, and the z-axis linear motion includes an upward and downward motion, the x-axis rotational motion includes a tilting side-to-side motion, the y-axis rotational motion includes a tilting forward and backward motion, and the z-axis rotational motion includes a turning left and right motion.

3. The electric motion chair of claim 2, wherein the one or more degrees of freedom further includes a first motion group, a second motion group, and a third motion group, the first motion group includes one or more of the x-axis linear motion, the y-axis linear motion, the z-axis linear motion, the x-axis rotational motion, the y-axis rotational motion, and the z-axis rotational motion, the second motion group includes one or more of the x-axis linear motion, the y-axis linear motion, the z-axis linear motion, the x-axis rotational motion, the y-axis rotational motion, and the z-axis rotational motion not included in the first motion group, and the third motion group includes one or more of the x-axis linear motion, the y-axis linear motion, the z-axis linear motion, the x-axis rotational motion, the y-axis rotational motion, and the z-axis rotational motion not included in the first motion group and the second motion group.

4. The electric motion chair of claim 3, further comprising a base, the base coupled to the chair, the base configured to support the chair thereon, the motor disposed in the chair or in the base, the motor configured to move the chair in the one or more degrees of freedom relative to the base, and wherein each one or more sensors is disposed in the chair or in the base.

5. The electric motion chair of claim 4, wherein the motor includes a first motor and a second motor, the first motor disposed in the base, the second motor disposed in the chair, the first motor configured to move the chair in the first motion group or the first motion group and the third motion group, and the second motor configured to move the chair in the second motion group or the second motion group and the third motion group, when the first motor is configured to move the chair in the first motion group and the third motion group, the second motor is configured to move the chair in the second motion group, and vice versa, and when the second motor is configured to move the chair in the second motion group and the third motion group, the first motor is configured to move the chair in the first motion group, and vice versa.

6. The electric motion chair of claim 4, further comprising a platform, the platform coupled to the chair and coupled to the base, the platform disposed between the chair and the base, the platform configured to support the chair thereon, the motor disposed in the chair, or in the base, or in the platform, and wherein each one or more sensors is disposed in the chair, or in the base, or in the platform.

7. The electric motion chair of claim 6, wherein the motor includes a first motor, a second motor, and a third motor, the first motor disposed in the base, the second motor disposed in the chair, and the third motor disposed in the platform, the first motor configured to move the chair in the first motion group, the second motor configured to move the chair in the second motion group, and the third motor configured to move the chair in the third motion group.

8. The electric motion chair of claim 1, wherein the motor is further configured to include a decelerated state, the decelerated state includes the motor moving the chair at a reduced speed relative to the activated state, wherein the respective relative distance of each one or more sensors configured to detect the object includes a deactivated distance and a decelerated distance, the decelerated distance is greater than the deactivated distance, and wherein the control system is further configured to automatically transition the motor from the activated state to the decelerated state when the object is at the decelerated distance, and configured to automatically transition the motor from the decelerated state to the deactivated state when the object is at the deactivated distance.

9. The electric motion chair of claim 8, wherein the control system is further configured to automatically transition the motor from the activated state to the decelerated state for a predetermined decelerated period of time when the object is at the decelerated distance.

10. The electric motion chair of claim 8, further comprising an alarm, the alarm configured to provide an audible warning or a visual warning or the audible warning and the visual warning, the control system further electrically coupled to the alarm, and wherein the respective relative distance of each one or more sensors configured to detect the object further includes a warning distance, the warning distance is greater than the decelerated distance, and wherein the control system is further configured to automatically trigger the alarm when the object is at the warning distance.

11. The electric motion chair of claim 10, wherein the alarm includes a display device, the display device configured to provide the audible warning and the visual warning.

12. The electric motion chair of claim 10, wherein the control system is further configured to automatically trigger the alarm for a predetermined alarm period of time when the object is at the warning distance.

13. The electric motion chair of claim 1, further comprising a user interface device, the control system further electrically coupled to the user interface device, the user interface device configured to generate an activation signal by a user, and wherein the control system is further configured to receive the activation signal and transition the motor from the deactivated state to the activated state when the activation signal is received.

14. The electric motion chair of claim 13, wherein the user interface device includes a touchscreen monitor, a mouse device, or a keyboard device or the touchscreen monitor and the mouse device or the touchscreen monitor and the keyboard device.

15. The electric motion chair of claim 1, wherein each one or more sensors is further configured to include a frequency, the frequency includes frequencies between 30 kHz and 80 kHz, inclusive.

16. The electric motion chair of claim 15, wherein the one or more sensors includes six one or more sensors, the one or more sensors circularly disposed, each neighboring one or more sensors disposed at an equal distance apart, and wherein each one or more sensors is further configured to include a beam angle, the beam angle includes a 60-degree beam angle.

17. The electric motion chair of claim 15, wherein the one or more sensors includes twelve one or more sensors, the one or more sensors equiangular quadrilateral disposed, each neighboring one or more sensors disposed at an equal distance apart, and wherein each one or more sensors is further configured to include a beam angle, the beam angle of each neighboring one or more sensors overlaps.

18. The electric motion chair of claim 1, wherein the object includes a living being or a non-living being.

19. The electric motion chair of claim 1, wherein the one or more sensors includes an ultrasonic sensor.

20. The electric motion chair of claim 1, wherein the control system includes one or more of a central processing unit, a processor, a controller circuit, and a programmable logic controller, or any combination of the central processing unit, the processor, the controller circuit, and the programmable logic controller.
